(19) United States
(12) Patent Application Publication
(10) Pub. No.: US 2025/0122937 A1
(43) Pub. Date: Apr. 17, 2025

(54) Spray Manifold

(71) Applicant: Stinger Equipment Inc., Buckner, KY (US)

(72) Inventor: David Michael Cook, Jekyll Island, GA (US)

(21) Appl. No.: 18/917,390

(22) Filed: Oct. 16, 2024

Related U.S. Application Data
(60) Provisional application No. 63/544,560, filed on Oct. 17, 2023.

(51) Int. Cl. F16K 11/044; A01C 23/04; B05B 15/20; B05B 15/40

(52) U.S. Cl. CPC F16K 11/044; A01C 23/047; B05B 15/20; B05B 15/40

(57) ABSTRACT

A manifold for use in a turf applicator spray system, the manifold includes: an inlet to receive fluid flow; a first and second outlet for directing the fluid flow; a valve plunger; a solenoid valve to raise and lower the valve plunger; a compression spring moveable between a compressed state and an uncompressed state; where when in the compressed state the valve plunger is compressed to send the fluid flow from the inlet to the first outlet and when in the uncompressed state the fluid flow is from the inlet to the second outlet.

### BACKGROUND OF THE INVENTION

The professional turf industry utilizes riding applicators that are designed to spray liquid chemical solutions to help maintain turf. Developments in turf science have led to different types of products, including “wettable powders”. Wettable powders are solids ground up to a fine powder that requires constant mixing in a tank to keep the product thoroughly mixed in a sprayable solution. Without this constant mixing, the product may settle to the bottom of the tank resulting in an uneven application of the product. Constant mixing may also prevent the clogging the spray system. These spray systems may be prone to clogging with use of these “wettable powders” as the powder that was supposed to be in liquid suspension may form a solid in the bottom of the tank, spray lines, strainer, or pump, especially if not well mixed.

Traditionally these wettable powders were only used with large golf course sprayers. Typically, these types of large golf course sprayers utilize a mechanical rotating paddle to mix the contents of the tanks to keep the product in constant suspension and/or they use one or more high flow venturi nozzles to mix the tank constantly. These types of mixing devices require a large tank and a significant amount of electrical and/or mechanical power to operate.

With the high demand for residential lawns to have the same level of care as golf courses, there is a need for smaller riding turf applicators to have the ability to accurately spray a liquid solution with wettable powders. To achieve this, these smaller sprayers are using larger spray pumps than ever before. However, this requires operators to turn a valve on and off to engage the tank mixing when needed. Further, these systems require a complex network of valves and/or multiple return lines back to the tanks.

There is a need in the industry for a more compact and simple method for using a single pump to both spray a liquid solution and mix a spray tank using a venturi return nozzle. Such a device should have the ability to very quickly switch between sending most of the pump flow to either the spray tips, or the mixing nozzle to keep the chemicals in full suspension.

### SUMMARY OF THE INVENTION

There is a need for a turf applicator with a single pump to be able to divert all or most of the flow from the spray pump to either the spray tips or the tank agitation nozzle almost instantly and then back again. This ability to quickly change from spraying to tank mixing allows a single pump to both spray and keep wettable powders in full suspension. For example, when an operator comes to the end of a spray pass and turns off the spray tips, the system will nearly instantly divert pump flow to the tank for mixing. Further, as the operator makes a turn and lines up for the next pass, the operator may turn the spray system back on and the flow is nearly instantly diverted back to the spray tips. The faster this process can switch back and forth the more time the system can mix the tank in order to prevent clogging. Once a product is in suspension, the solution needs intermittent agitation to stay in suspension.

In a first aspect, a manifold for use in a turf applicator spray system includes: an inlet to receive fluid flow; a first outlet and a second outlet for directing the fluid flow; a valve plunger; a solenoid valve to raise and lower the valve plunger; a compression spring moveable between a compressed state and an uncompressed state; where when the compression spring is in the compressed state the valve plunger is compressed to send the fluid flow from the inlet to the first outlet; where when the compression spring is in the uncompressed state the fluid flow is from the inlet to the second outlet.

In some implementations, the manifold is Injection molded. In some implementations, the inlet is connected to a spray tank to receive the fluid flow from the spray tank. In some such implementations, the manifold further includes an orifice in the manifold through which fluid flows to the spray tank for tank agitation. In some implementations, the second outlet directs the fluid flow to the spray tank for tank agitation.

In some implementations, the first outlet directs the fluid flow to one or more spray tips. In some implementations, the manifold further includes an O-ring disposed on the manifold to seal the solenoid valve against the manifold. In some implementations, the manifold further includes a pressure transducer to monitor spray pressure.

In another aspect, a spray system for use in a turf applicator includes: a spray tank for holding a fluid material; one or more spray tips for dispensing the fluid material; an injection molded manifold, wherein the manifold includes: an inlet connected to the spray tank and configured to receive fluid flow from the spray tank; a first outlet and a second outlet for directing the fluid flow; a valve plunger; a solenoid valve to raise and lower the valve plunger; and a compression spring moveable between a compressed state and an uncompressed state; where when the compression spring is in the compressed state the valve plunger is compressed to send the fluid flow from the inlet to the first outlet to the one or more spray tips; wherein when the compression spring is in the uncompressed state the fluid flow is from the inlet to the second outlet to the spray tank for tank agitation; and an orifice in the manifold through which fluid flows to the spray tank for tank agitation.

In some implementations, the spray system for use in a turf applicator further includes an O-ring disposed on the manifold to seal the solenoid valve against the manifold. In some implementations, the spray system for use in a turf applicator further includes a pressure transducer to monitor spray pressure. In some implementations, the spray system for use in a turf applicator further includes a strainer and a bulkhead, where the fluid flow exits the spray tank through the bulkhead and passes through the strainer. In some implementations, the spray system for use in a turf applicator further includes a spray wand and a manual valve for control of the fluid flow to the spray wand.

### BRIEF DESCRIPTION OF THE DRAWINGS

In order that the embodiments may be better understood, embodiments of a manifold and spray system will now be described by way of examples. These embodiments are not to limit the scope of the claims as other embodiments of a spray manifold will become apparent to one having ordinary skill in the art upon reading the instant description. Non-limiting examples of the present embodiments are shown in figures.

FIG. 1. is an isometric view of a spray manifold assembly consistent with some embodiments described herein.

FIG. 2. is an exploded view of the spray manifold assembly of FIG. 1.

FIG. 3. is an isometric view showing the flow directions of the spray manifold assembly consistent with some embodiments described herein.

FIG. 4. illustrates a manifold showing the orifice that always returns flow back to the tank consistent with some embodiments described herein.

FIG. 5. illustrates a spray system with the spray tank consistent with some embodiments described herein.

FIG. 6. illustrate the spray system of FIG. 5 with the spray tank removed for ease of viewing.

FIG. 7. illustrate the spray system of FIG. 6 with the spray wand, spray wand valve, and spray wand hoses removed for ease of viewing.

FIG. 8. is an isometric view of a compact turf applicator utilizing the spray system of FIG. 5.

### DETAILED DESCRIPTION OF THE INVENTION

It is to be understood that a spray manifold is not limited in its application to the details of construction and the arrangement of components set forth in the following description or illustrated in the drawings. The described embodiments are capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment but may. Furthermore, the particular features, structures or characteristics may be combined in any suitable manner, as would be apparent to one of ordinary skill in the art from this disclosure, in one or more embodiments.

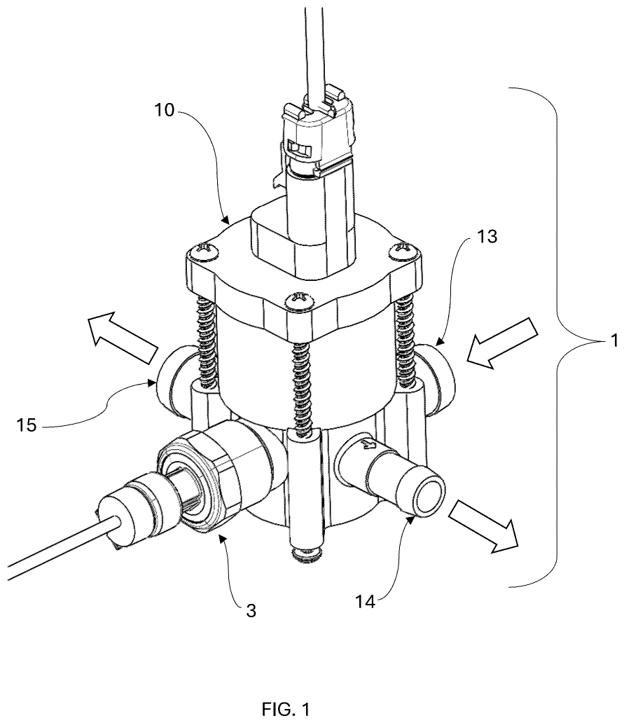

FIG. 1 shows a manifold assembly 1 with the ability to nearly instantly divert spray flow from the inlet 13 to either of the two outlets (14, 15). The manifold assembly 1 can send most or all of the flow to either a first outlet 15 that, for example may direct flow to the spray tips or a second outlet 14 that, for example, may direct flow to the spray tank for maximum tank agitation. In some implementations, the manifold assembly 1 may also include a pressure transducer 3 which is used to monitor spray pressure. In some implementations, the manifold assembly 1 may also include a solenoid 10 which may be used to quickly divert flow from the first outlet 15 to the second outlet 14 or vice versa.

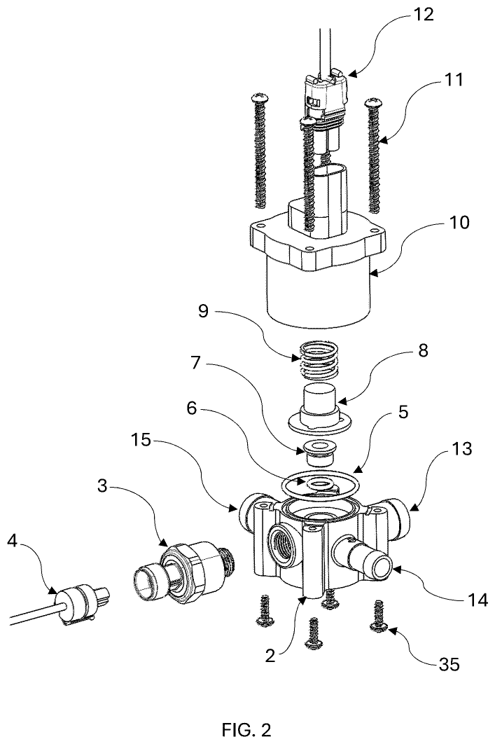

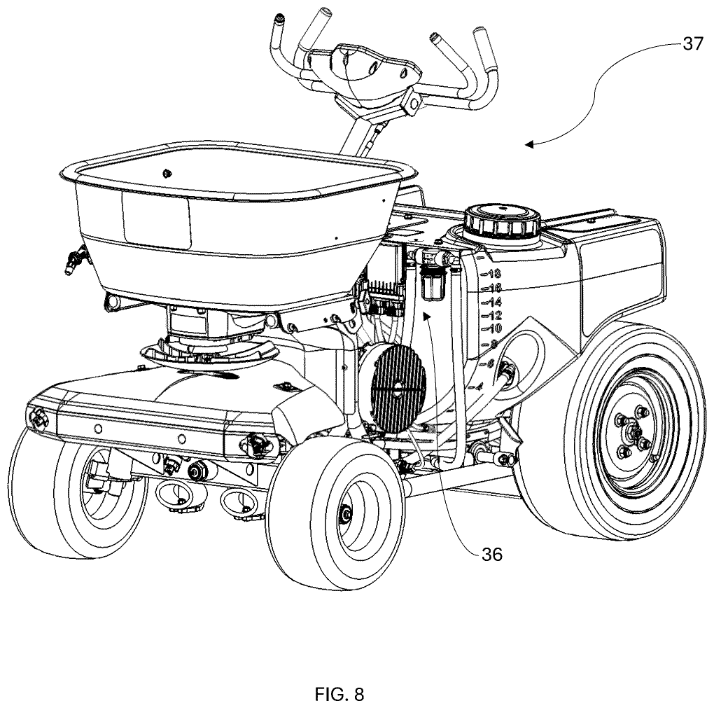

FIG. 2 shows an exploded view of all the components in the manifold assembly 1. The assembly has a manifold 2, which in some implementations may be injection molded. The manifold 2 encompasses a solenoid 10 that raises and lowers a valve plunger 8. The valve plunger 8 is held down against a valve seat 7 using a compression spring 9. When compressed by the spring 9, valve plunger 8 and valve seat 7 act in combination to send the flow of material from the inlet 13 to the first outlet 15 and then to the spray tips (not illustrated in FIG. 2). In addition to the valve seat 7, there is also an o-ring 6 pressed into the manifold 2. The o-ring 5 may be used to seal the solenoid valve 10 against the manifold 2. The solenoid 10 may be, in some instances, attached to manifold 2 using four screws 11, although a person of skill in the art would recognize there are numerous methods of attaching the solenoid 10 to the manifold 2. The solenoid 10 may be electrically connected to a controller (not shown) using a harness connector 12. A pressure transducer 3 may also be connected to the controller (not shown) using wiring harness connector 4 to monitor spray pressure. The manifold assembly 1 may be attached to an applicator frame (see FIG. 8) using screws 35.

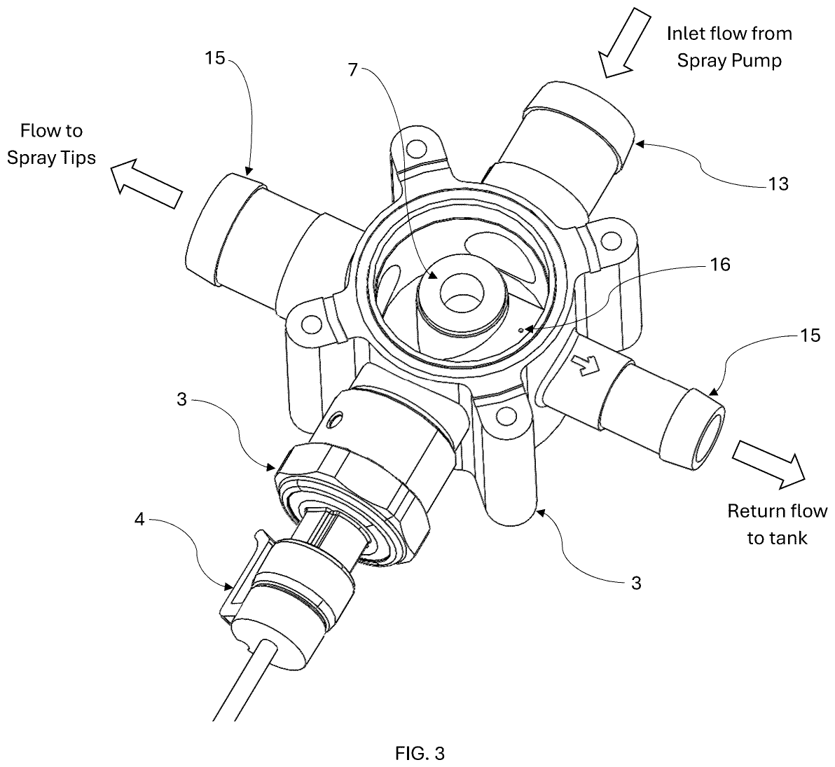

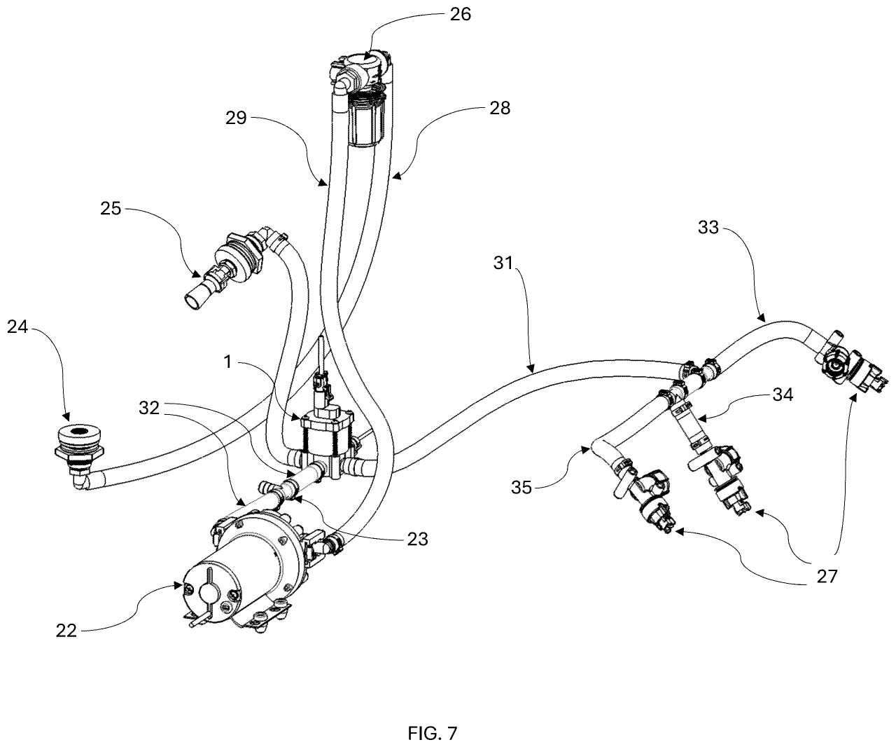

FIG. 3 shows the manifold 2, which may be injection molded, with the pressure transducer 3 and valve seat 7. The manifold 2 allows liquid or wettable powders in solution to flow from the inlet 13 to the first outlet 15 when the solenoid valve 10 is closed and not energized. In contrast when the solenoid valve 10 is energized, flow is allowed to exit from the second outlet 14 and to return back to the tank (not illustrated). When the solenoid valve 10 is energized, the spray tip(s) (see reference number 27 in FIG. 7) are turned off so all the flow from the pump (see reference number 22 in FIG. 7) can be diverted nearly instantly back to the tank.

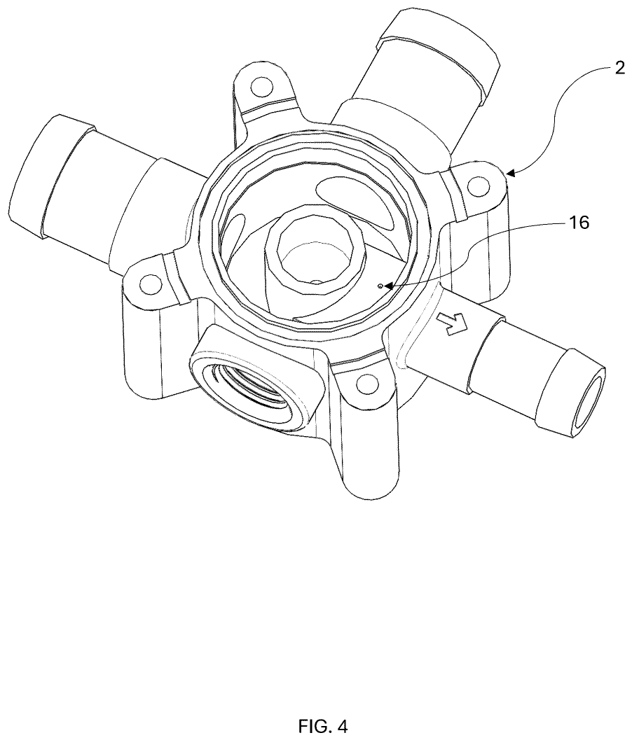

FIG. 4 shows orifice 16 in the manifold 2. In the illustrated embodiment, the orifice 16 is about 0.035″ in diameter, and allows approximately 0.3 gallons per minute to pass through the orifice 16. The orifice 16 provides two functions. First, the orifice 16 acts as a pressure release when the pump (see reference number 22 in FIG. 7) turns off. Second, the orifice 16 may also act as a port for low flow tank agitation that runs constantly whenever the pump is running and holding pressure on the spray system. The orifice 16 can be larger or smaller depending on how much continuous tank agitation is desired. Additionally, the orifice 16 may also be any shape. The orifice 16 allows for fluid and/or wettable powder can be returned to the tank.

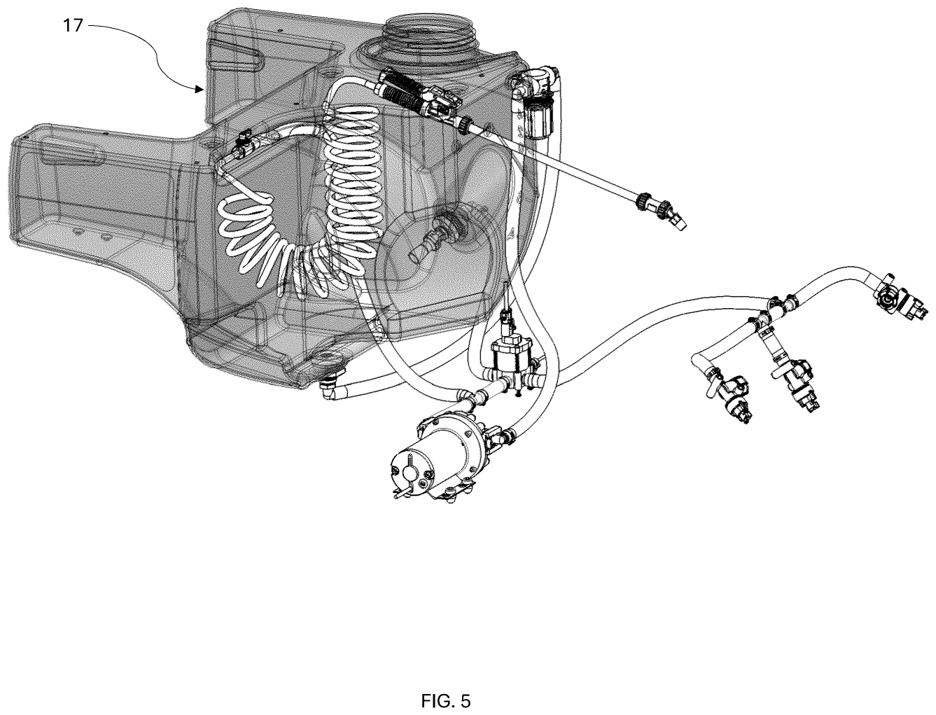

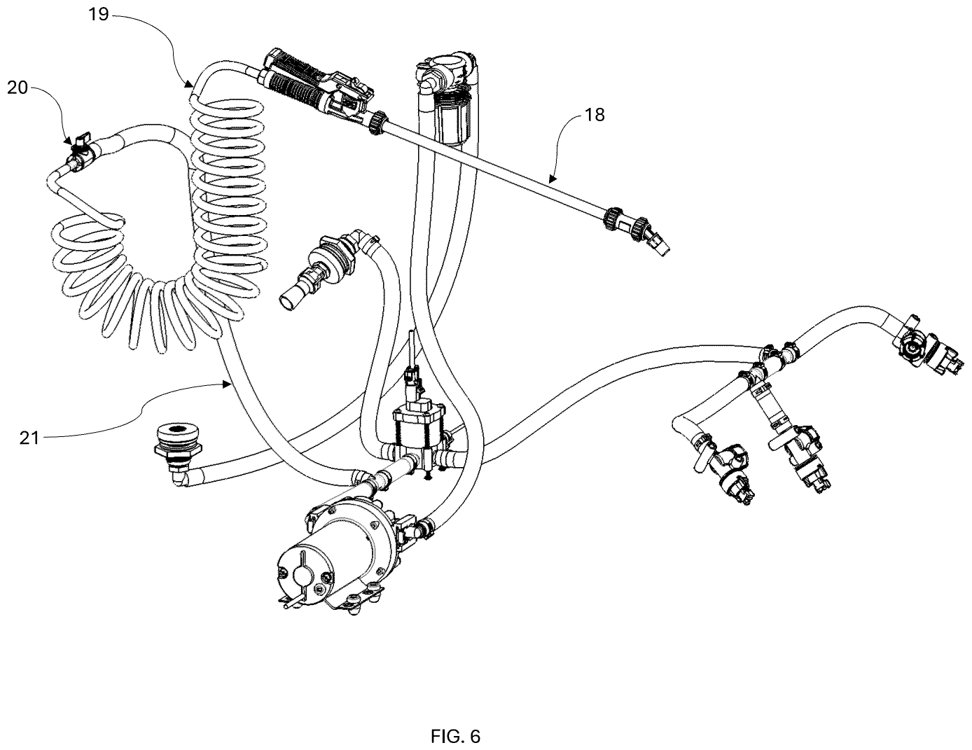

FIG. 5 shows a spray system using the manifold assembly 1 described previously herein with an attached spray tank 17. FIG. 6 illustrates the same spray system with the spray tank 17 removed to allow a clear view of the major components. FIG. 6 shows a hand spray wand 18 that can be used to spray small areas by hand. A manual valve 20 can be used by a user to manually turn off all flow to the spray wand 18, for example, in the event there is damage to the spray hose 19 or spray wand 18.

FIG. 7 illustrates additional details of the spray system from FIG. 6 with the spray wand 18, spray hose 19, and related components removed. The flow from the spray tank 17 (not illustrated in FIG. 7) exits the tank through a lower bulkhead 24 to a strainer 26 and then through a first transport hose 28. The strainer 26 may filter out dirt and/or large particles before they reach the spray pump 22 to prevent clogging. As a non-limiting example, the strainer 26 may filter out large clumps of “wettable powders” or one or more leaves that may have fallen in the tank when filling. After passing through the strainer 26 the fluid flows through a second transport hose 29 and to a spray pump 22. The fluid exits the spray pump 22 under high pressure through hoses 32 in between which a “T” fitting 23 is disposed and into the manifold assembly 1.

When the solenoid valve 10 in the manifold assembly 1 is not energized, most of the flow is allowed to flow to the spray tips 27 through one or more spray hoses 31, 34, and 35. A portion of the flow (approximately 0.3 gallons per minute) may continually flow back to the spray tank (not illustrate) to allow for minimal tank agitation. In a non-limiting example, all of the material flows to the spray tips 27 through one or more spray hoses 31, 34, and 35 minus the flow of material through the orifice 16 back to the tank for mixing. In this state, the spray system will spray when the spray tips 27 are energized allowing the spray tips to open.

When the solenoid valve 10 in the manifold assembly 1 is energized, the valve seat 7 will move (e.g., lift) to allow flow through tank return outlet 14 (see FIGS. 1-3) of the manifold 2. In this state, when the spray pump 22 is running and the spray tips 27 are not energized, 100% of the flow from the spray pump 22 will exit the manifold tank return outlet 14, travel through a hose 30 to the tank return bulkhead 24 and exit venturi nozzle 25 aggressively mixing the solutions in the spray tank 17.

FIG. 8 shows the spray system 36 using the manifold assembly 1 described previously herein installed in a riding turf applicator 37.

1. A manifold for use in a turf applicator spray system, the manifold comprising:
an inlet to receive fluid flow;
a first outlet and a second outlet for directing the fluid flow;
a valve plunger;
a solenoid valve to raise and lower the valve plunger;
a compression spring moveable between a compressed state and an uncompressed state;
wherein when the compression spring is in the compressed state the valve plunger is compressed to send the fluid flow from the inlet to the first outlet;
wherein when the compression spring is in the uncompressed state the fluid flow is from the inlet to the second outlet.

2. The manifold for use in a turf applicator spray system of claim 1, wherein the manifold is Injection molded.

3. The manifold for use in a turf applicator spray system of claim 1, wherein the inlet is connected to a spray tank to receive the fluid flow from the spray tank.

4. The manifold for use in a turf applicator spray system of claim 3 further comprising an orifice in the manifold through which fluid flows to the spray tank for tank agitation.

5. The manifold for use in a turf applicator spray system of claim 3, wherein the second outlet directs the fluid flow to the spray tank for tank agitation.

6. The manifold for use in a turf applicator spray system of claim 1, wherein the first outlet directs the fluid flow to one or more spray tips.

7. The manifold for use in a turf applicator spray system of claim 1 further includes an O-ring disposed on the manifold to seal the solenoid valve against the manifold.

8. The manifold for use in a turf applicator spray system of claim 1 further includes a pressure transducer to monitor spray pressure.

9. A spray system for use in a turf applicator, the spray system comprising:
a spray tank for holding a fluid material;
one or more spray tips for dispensing the fluid material;
an injection molded manifold, wherein the manifold includes:
an inlet connected to the spray tank and configured to receive fluid flow from the spray tank;
a first outlet and a second outlet for directing the fluid flow;
a valve plunger;
a solenoid valve to raise and lower the valve plunger;
a compression spring moveable between a compressed state and an uncompressed state;
wherein when the compression spring is in the compressed state the valve plunger is compressed to send the fluid flow from the inlet to the first outlet to the one or more spray tips;
wherein when the compression spring is in the uncompressed state the fluid flow is from the inlet to the second outlet to the spray tank for tank agitation; and
an orifice in the manifold through which fluid flows to the spray tank for tank agitation.

10. The spray system for use in a turf applicator of claim 9 further includes an O-ring disposed on the manifold to seal the solenoid valve against the manifold.

11. The spray system for use in a turf applicator of claim 9 further includes a pressure transducer to monitor spray pressure.

12. The spray system for use in a turf applicator of claim 9 further includes a strainer and a bulkhead, and wherein the fluid flow exits the spray tank through the bulkhead and passes through the strainer.

13. The spray system for use in a turf applicator of claim 9 further includes a spray wand and a manual valve for control of the fluid flow to the spray wand.
